(19) United States
(12) Patent Application Publication
(10) Pub. No.: US 2025/0336403 A1
(43) Pub. Date: Oct. 30, 2025

(54) METHOD, DEVICE, AND PROGRAM PRODUCT FOR DETERMINING SOURCE OF SYNTHESIZED AUDIO

(71) Applicant: Dell Products L.P., Round Rock, TX (US)

(72) Inventors: Zijia Wang, London (GB); Qiang Chen, Shanghai (CN); Sanping Li, Beijing (CN); Zhen Jia, Shanghai (CN)

(21) Appl. No.: 18/678,143

(22) Filed: May 30, 2024

(30) Foreign Application Priority Data
Apr. 24, 2024 (CN) 202410501590.X

(51) Int. Cl. G10L 19/018; G10L 19/06

(52) U.S. Cl. CPC G10L 19/018; G10L 19/06

(57) ABSTRACT

A method in an illustrative embodiment includes generating structured noise of first synthesized audio based on the first synthesized audio, and fusing a digital watermark into the structured noise. The method further includes determining a target embedding position of the digital watermark based on a spectrum of the first synthesized audio, wherein the digital watermark indicates a source of the first synthesized audio. In addition, the method further includes generating second synthesized audio based on the fused structured noise, the first synthesized audio, and the target embedding position. Through the method, not only is content of original audio preserved, but also a watermark is added, allowing a source of the audio to be recorded and traced. At the same time, the method further has a high degree of covertness, robustness, and flexibility, thereby providing a safer and more reliable environment for the synthesized audio, and improving the user experience.

### RELATED APPLICATION

The present application claims priority to Chinese Patent Application No. 202410501590.X, filed Apr. 24, 2024, and entitled “Method, Device, and Program Product for Determining Source of Synthesized Audio,” which is incorporated by reference herein in its entirety.

### FIELD

The present disclosure generally relates to the field of computers, and more particularly, to a method, a device, and a program product for determining a source of synthesized audio.

### BACKGROUND

A watermark is a transparent mark embedded in a picture, a video, or a document, for identifying an author, copyright information, or other related content. It may be used as both an anti-counterfeiting technology and a beautification effect. Watermarks may be classified into two types: visible watermarks and invisible watermarks.

In the field of audio generation, taking music generation as an example, the application of watermarking technology in music generation is gradually increasing. Music generation refers to creating a new musical work by using artificial intelligence technology. This process involves the application of technologies such as machine learning and deep learning, enabling artificial intelligence to mimic and learn styles and music structures of musicians, thereby generating similar musical works. Audio watermarking technology is a technology that embeds digital watermarks into audio signals. In practical applications, audio watermarking technology is widely applied in fields such as intellectual property protection, broadcast monitoring, telephone privacy protection, and broadcast promotion.

### SUMMARY

Embodiments of the present disclosure provide a method, a device, and a computer program product for determining a source of synthesized audio.

In a first aspect of embodiments of the present disclosure, a method for determining a source of synthesized audio is provided. The method includes generating structured noise of first synthesized audio based on the first synthesized audio. The method further includes fusing a digital watermark into the structured noise. The method further includes determining a target embedding position of the digital watermark based on a spectrum of the first synthesized audio, wherein the digital watermark indicates a source of the first synthesized audio. In addition, the method further includes generating second synthesized audio based on the fused structured noise, the first synthesized audio, and the target embedding position.

In a second aspect of embodiments of the present disclosure, an electronic device is provided. The electronic device includes at least one processor and a memory coupled to the at least one processor and having instructions stored therein. The instructions, when executed by the at least one processor, cause the electronic device to perform actions. The actions include generating structured noise of first synthesized audio based on the first synthesized audio, fusing a digital watermark into the structured noise, determining a target embedding position of the digital watermark based on a spectrum of the first synthesized audio, wherein the digital watermark indicates a source of the first synthesized audio, and generating second synthesized audio based on the fused structured noise, the first synthesized audio, and the target embedding position.

In a third aspect of the present disclosure, a computer program product is provided. The computer program product is tangibly stored on a non-transitory computer-readable medium and comprises machine-executable instructions. The machine-executable instructions, when executed by a machine, cause the machine to perform actions. The actions include generating structured noise of first synthesized audio based on the first synthesized audio, fusing a digital watermark into the structured noise, determining a target embedding position of the digital watermark based on a spectrum of the first synthesized audio, wherein the digital watermark indicates a source of the first synthesized audio, and generating second synthesized audio based on the fused structured noise, the first synthesized audio, and the target embedding position.

It should be understood that the content described in this Summary is neither intended to limit key or essential features of embodiments of the present disclosure, nor intended to limit the scope of the present disclosure. Other features of the present disclosure will become readily understood from the additional description provided herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 is a schematic diagram of an example environment in which a plurality of embodiments of the present disclosure can be implemented;

FIG. 2 is a flow chart of a method for determining a source of synthesized audio according to some embodiments of the present disclosure;

FIG. 3 is a schematic diagram illustrating information carried by a digital watermark according to some embodiments of the present disclosure;

FIG. 4 is a schematic diagram of a process for embedding a digital watermark and structured noise into synthesized audio according to some embodiments of the present disclosure;

FIG. 5 is a schematic diagram of a process for detecting whether audio carries a digital watermark according to some embodiments of the present disclosure;

FIG. 6 is a schematic diagram of a process for training embedding model according to some embodiments of the present disclosure; and

FIG. 7 is a block diagram of a device that can implement a plurality of embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

With the rapid development of the field of machine-generated audio, watermarking technology has been used to determine the copyright ownership of generated audio. The traditional watermarking technology performs well in static recognition of audio ownership. However, when audio with watermarks is used as training data for a machine learning model, watermark information may be lost or tampered with in a training process. This means that even if original audio carries watermarks, audio generated by the machine learning model may not be able to effectively retain the watermark information, thereby increasing the difficulty in copyright ownership and data tracing.

In view of this, embodiments of the present disclosure provide a solution for determining a source of synthesized audio. In embodiments of the present disclosure, firstly, some structured noise may be generated for original audio to make the audio sound natural. At the same time, the structured noise may also be able to help hide some watermark information, so that the embedded watermark information can be detected while being robust. Moreover, the design of the structured noise may also affect a third-party machine learning model. At the same time, in order to prevent the embedded watermark information from affecting the original audio, an appropriate target embedding position may be determined according to a spectrum of the original audio. In this way, the embedded watermark information and structured noise in an output new audio may not be easily perceived by the human auditory system. This method of fusing a digital watermark into structured noise and embedding such components into original audio to generate a new audio not only preserves the content of the original audio, but further provides a protection, so that its source can be traced, it is ensured that its copyright is not infringed, and further it is ensured that the watermark information carried by the newly generated audio is not tampered with or deleted during a third-party operation.

Through this method, the digital watermark and the structured noise information in the generated new audio have imperceptibility, robustness, and flexibility. It can not only trace the copyright of the audio, but also provide security guarantees for the training and use of a machine-generated audio model. Therefore, the user experience is improved.

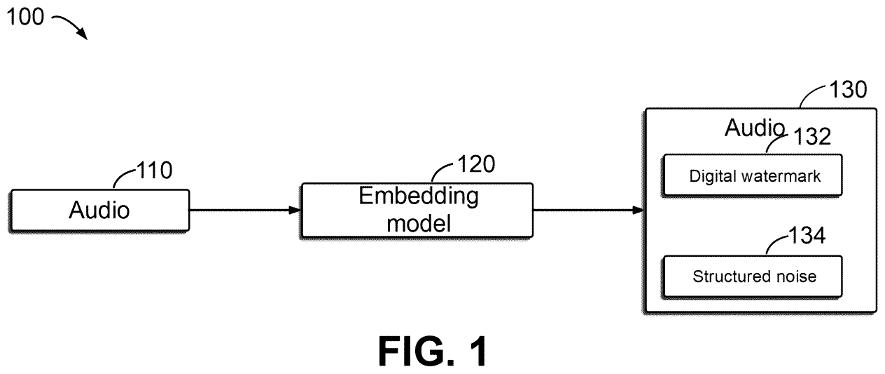

FIG. 1 is a schematic diagram of an example environment 100 in which a plurality of embodiments of the present disclosure can be implemented. As shown in FIG. 1, by inputting audio 110 into an embedding model 120, audio 130 carrying a digital watermark 132 and structured noise 134 may be obtained. An embedding process of the embedding model 120 involves analysis and processing of the input audio 110, and in this way, it can ensure that the embedding of the digital watermark 132 and the structured noise 134 is covert and effective. In some embodiments, by analyzing a spectrum of the audio 110, a suitable target embedding position may be found.

Still referring to FIG. 1, in some embodiments, the digital watermark 132 may include timestamp information of the audio 110, information of a generator that generates the audio 110, and relevant information of a model that generates the audio 110. In some embodiments, the digital watermark 132 and the structured noise 134 are not easily perceptible to the human auditory system. In other words, when an audience is playing the audio 130 carrying the digital watermark 132 and the structured noise 134, he/she cannot perceive any other information that has already been added to the audio 130. In some embodiments, the generated audio 130 is used as a training dataset for a third-party model to train the third-party model, and a generated output audio also carries relevant information of the digital watermark 132.

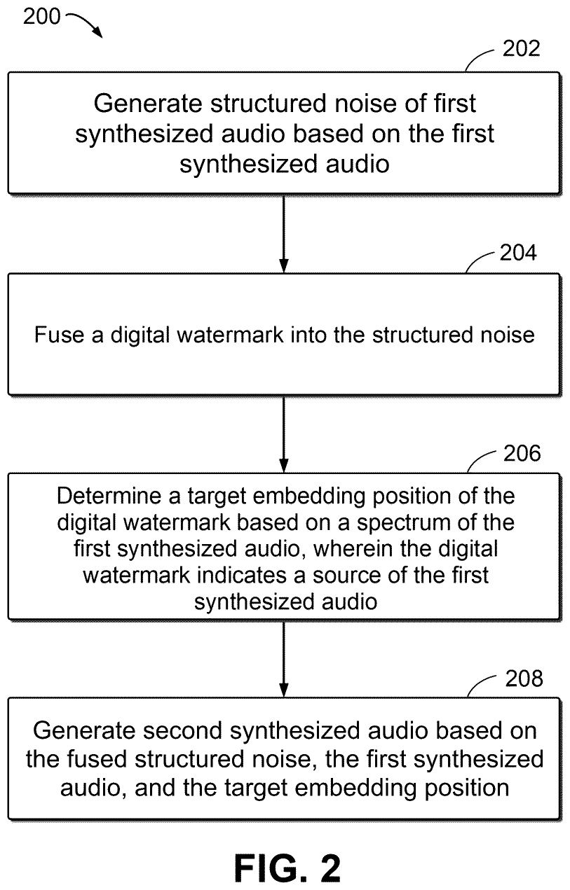

FIG. 2 is a flow chart of a method 200 for determining a source of synthesized audio according to some embodiments of the present disclosure. At a block 202, structured noise of first synthesized audio is generated based on the first synthesized audio. In some embodiments, the structured noise is constructed in a special manner so that it is almost imperceptible to human hearing in the audio but can be recognized by a specialized detection system. In some embodiments, the structured noise is formed by generating a pseudo-random sequence and then modulating it.

At block 204, a digital watermark is fused into the structured noise. In some embodiments, the digital watermark may be converted into a digital signal through an encoding function. In some embodiments, the digital watermark converted into the digital signal is fused with the structured noise.

At block 206, a target embedding position of the digital watermark is determined based on a spectrum of the first synthesized audio, wherein the digital watermark indicates a source of the first synthesized audio. In some embodiments, the digital watermark includes source information of original audio. In some embodiments, an embedding position of the digital watermark may be found by analyzing a frequency domain of the original audio. For example, those regions that are least sensitive to human hearing and have relatively simple content are suitable target embedding positions. In some embodiments, when appropriate embedding positions are determined, these suitable embedding positions may be marked.

At block 208, second synthesized audio is generated based on the fused structured noise, the first synthesized audio, and the target embedding position. In some embodiments, according to the target embedding position determined by the spectrum of the original audio, information formed by the fusion of the digital watermark and the structured noise is embedded into the original audio to generate a new audio carrying the digital watermark.

With the help of the structured noise, it can be ensured that the audio quality embedded with the watermark is similar to that of the original audio, so that the addition of the watermark and the structured noise will not affect the audience experience. Moreover, this structured noise mode can enable the generated new audio to still maintain high detectability after certain processing or transformation. In order to reduce the impact of the embedding of the watermark and the structured noise on the audio, the appropriate target embedding position is determined by analyzing spectral characteristics of the original audio. The information that fuses the structured noise and can indicate the audio source is embedded into the original audio according to the appropriate target embedding position to generate the new audio. This new audio not only has the quality and content of the original audio, but also has copyright protection and tracing functions, so that even when the newly generated audio has been transformed or altered, the embedded watermark information can still be detected.

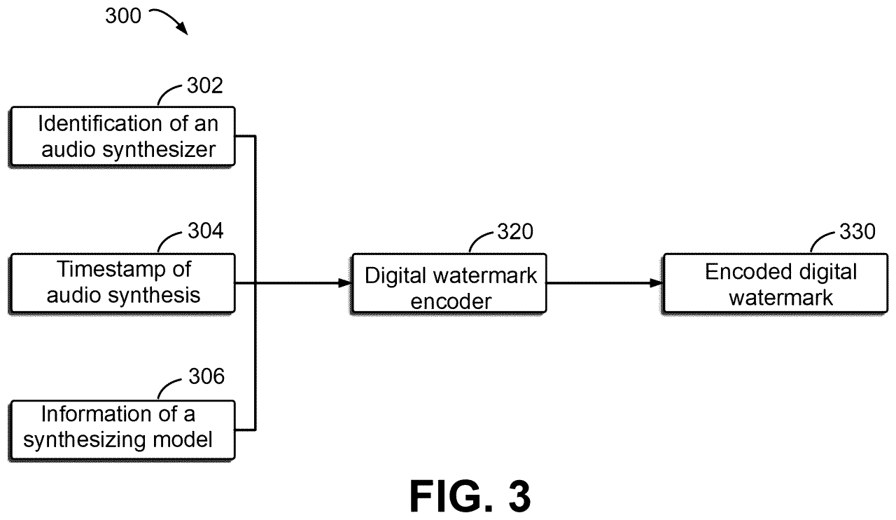

FIG. 3 is a schematic diagram illustrating information 300 carried by a digital watermark according to some embodiments of the present disclosure. A watermark in audio carrying a digital watermark shown in FIG. 3 may carry the information shown in FIG. 3. More particularly, an identification 302 of an audio synthesizer, a timestamp 304 of audio synthesis, and information 306 of a synthesizing model for synthesizing the audio are integrated. By using a digital watermark encoder 320, an encoded digital watermark 330 may be obtained. In this way, enough copyright authentication information may be carried through the watermark. Specifically, as shown in Equation (1):

$$W = ( {ID}_{gen} , {M}_{details} , {TS}_{gen} ) \qquad ( 1 )$$

wherein the identification (ID_{gen}) 302 of the audio synthesizer is usually a unique identifier, which may be the name, ID number, or another form of encoding of the synthesizer for clearly identifying a creator of an audio work. By encoding the identification 302 of the audio synthesizer into the encoded digital watermark 330, the true synthesizer of the audio can be quickly located to protect his/her legitimate rights and interests.

As shown in FIG. 3, the timestamp (TS_{gen}) 304 of the audio synthesis records the specific synthesis time of the audio. This information is crucial for determining the originality and the chronological order of the audio. In the process of audio synthesis, the existence of the timestamp can effectively prevent others from stealing. The information (M_{details}) 306 of the synthesizing model used for synthesizing the audio records detailed information such as the type, parameters, and training data of the synthesizing model used for generating the audio. This information helps trace and verify a generation process of the synthesized audio, thereby preventing abuse or tampering. In some embodiments, the watermark information may be encoded into a digital signal through an encoding function. Specifically, as shown in Equation (2):

$${S}_{w} = f ( W ) \qquad ( 2 )$$

wherein ƒ is the encoding function. The digital signal generated by the encoding function may be embedded into an audio track. In some embodiments, the digital signal of the digital watermark may be fused with the structured noise. After the three items of data are integrated, they will be input into the digital watermark encoder 320 for processing. The digital watermark encoder 320 is a technical tool specifically used for embedding specific information into multimedia data. After being processed by the digital watermark encoder 320, the encoded digital watermark 330 will become identification information closely integrated with the audio. It can not only be automatically carried along with the propagation of the audio, but also be detected and verified through a corresponding decoding technology when needed. Through this method, the source of the synthesized audio can be identified, thereby avoiding the abuse or theft of the synthesized audio by third parties.

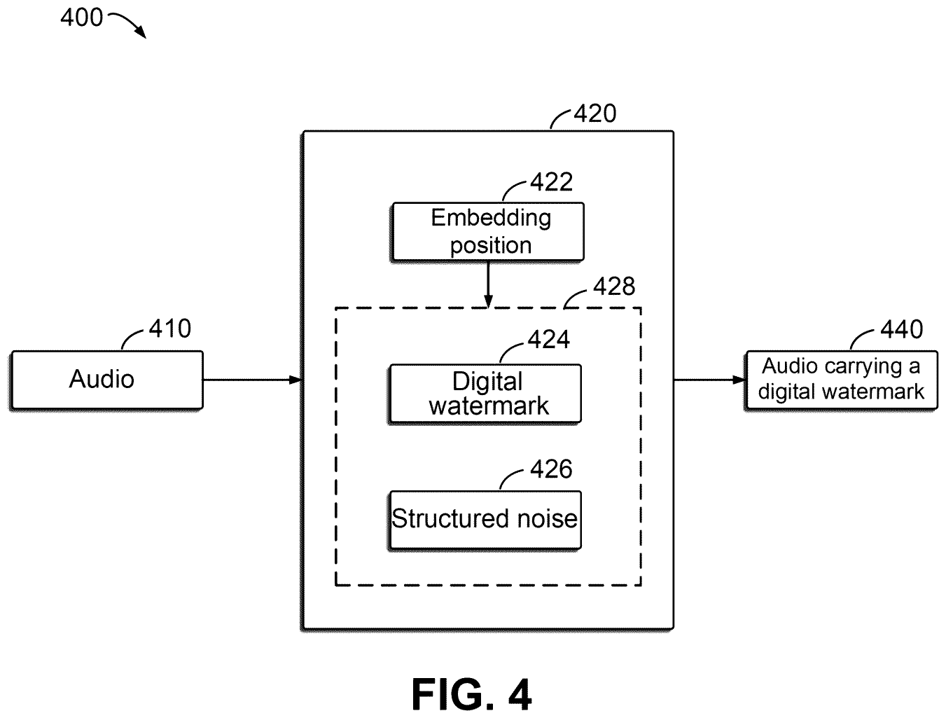

FIG. 4 is a schematic diagram of a process 400 of embedding a digital watermark and structured noise into synthesized audio according to some embodiments of the present disclosure. As shown in FIG. 4, synthesized audio 410 serves as an original carrier, and through the processing of an embedding model 420, audio 440 carrying a digital watermark 424 may be generated. The encoded digital watermark 330 shown in FIG. 3 is the digital watermark 424 shown in FIG. 4.

In order to embed the digital watermark 424 and structured noise 426 into the synthesized audio 410, it is necessary to find a suitable target embedding position in the synthesized audio 410 through an embedding position 422. These target embedding positions are usually redundant positions in an audio signal and are not easily perceived by the human auditory system. In some embodiments, a potential target embedding position may be searched for in a spectrum of the audio.

In some embodiments, the target embedding position may be determined according to the sensitivity of the human auditory system and the complexity of audio content. Specifically, as shown in Equation (3):

$$E = \{ ( f , t ) \vert S ( f , t ) \leq {T}_{H} and Ω ( f , t ) \leq {T}_{C} \} \qquad ( 3 )$$

wherein S(ƒ, t) is the short-time spectrum representation, T_{H} represents the human auditory threshold, Ω(ƒ, t) represents the complexity of audio content, and T_{C} represents the complexity threshold.

As shown in Equation (3), the short-time spectrum representation S(ƒ, t) is the spectral intensity or amplitude representation of an audio signal at a specific frequency ƒ and time t. In some embodiments, it is obtained by a Short-Time Fourier Transform (STFT) or another time-frequency analysis method to describe distribution of audio signals in time and frequency. By analyzing S(ƒ, t), activity levels of the audio signal at different time and frequencies can be understood, which is crucial for determining the target embedding position. Still referring to Equation (3), T_{H} is a specific sound intensity or spectral intensity level, below which audio signals are usually imperceptible by the human auditory system. This threshold is determined based on physical and physiological characteristics of the human auditory system, taking into account changes in the sensitivity of the human auditory system to different frequencies of sound. By utilizing psychoacoustic properties, the watermark is embedded in the least sensitive region of human hearing in audio data, thereby ensuring that the watermark remains robust even when encountering intentional or unintentional audio changes.

Still referring to Equation (3), Ω(ƒ, t) is a metric describing the complexity degree of an audio signal at a specific frequency f and time t. The complexity may involve a plurality of aspects of the audio signal, such as spectral density, relative intensity between different frequency components, and dynamic range of the signal. An audio region with a low complexity typically contains a small amount of audio information, so that it is more suitable to serve as a target embedding position.

Still referring to Equation (3), T_{C} is a threshold used for determining whether the audio is “relatively idle” and suitable for watermark embedding. When the complexity Ω(ƒ, t) of the audio content is lower than the threshold, it may be considered that the region is suitable for watermark embedding. By setting an appropriate T_{C}, embedding positions that have a small impact on the perception quality of the original audio can be determined.

Returning to FIG. 4, for example, if the intensity of a certain segment of signal of the audio cannot be perceived by the human auditory system and the complexity of the audio content at a specific frequency and time is relatively low, it may be considered that this segment of spectrum is an embeddable space. In some embodiments, the complexity of audio content of the audio at a specific frequency and time being relatively low refers to a relatively gentle frequency change or relatively low intensity.

To ensure the imperceptibility of the structured noise and the digital watermark, it is necessary to identify the embedding space of the audio in a frequency domain. By analyzing the short-time spectrum representation S(ƒ, t) of audio clips, potential embedding regions may be located. The selection of the embedding positions is based on the sensitivity of the human auditory system and the complexity of the audio content: these positions will be selected as target embedding positions only when S(ƒ, t) is below the human auditory threshold T_{H} and Ω(ƒ, t) is lower than the complexity threshold T_{C}. Next, these selected embedding spaces will be marked for subsequent integration of the structured noise. In some embodiments, the structured noise is formed by modulating a pseudo-random sequence. In some embodiments, the pseudo-random sequence may be modulated by using Gaussian distribution or another distribution method. Specifically, as shown in Equation (4):

$${N}_{s} = modulate ( pseudo\_random \_sequence ( ) ) \qquad ( 4 )$$

wherein pseudo_random_sequence() is used for generating the pseudo-random sequence.

In some embodiments, the generated digital watermark 424 may be fused into the structured noise 426. In some embodiments, by using the embedding model 420, structured noise 428 that has already been fused with the digital watermark may be embedded into the audio 410 according to the target embedding position, so as to obtain the audio 440 carrying the digital watermark 424. Specifically, as shown in Equation (5):

$${A}^{′} = g ( A , E , {I}_{{N}_{s} , W} ) \qquad ( 5 )$$

wherein A is the audio 410, A′ is the audio 440, and I_{N}_{_{S,}}_{w} is the digital watermarked structured noise 428 that is fused with the digital watermark.

The structured noise fused with the watermark information is embedded into the audio, which can achieve the signature mechanism of the model. Another audio generation model is trained by using the generated audio carrying the digital watermark and the structured noise. In the training process, the other audio generation model may learn the structured noise that is fused with the watermark information and fuse it into a weight and a bias of the other audio generation model. In this way, even if the input music does not have a watermark, the trained other audio generation model may still have a specific watermark signature when generating audio due to internalizing these noise characteristics.

For example, assume that there is a music generation model that is trained based on a large amount of music data carrying a specific watermark, and the watermark is a series of imperceptible audio signals. When the model is trained, it may attempt to learn and replicate various features of the music data, including melody, harmony, rhythm, and the like, as well as those imperceptible watermark signals. As the training progresses, the model not only learns how to generate music, but also inadvertently “remembers” characteristics of those watermark signals. These characteristics are fused into a weight and a bias of the model, becoming a part of the model. Therefore, even if a brand new watermark-free music clip is used as an input, this trained model, when generating an output, may also exhibit a certain recognizable watermark signature in the output because it has already been fused with the characteristics of the watermark internally.

This type of signature is not directly added to the output, but rather appears as a natural result in the model training process. Therefore, no matter how many pieces of music are generated, as long as they are generated by the same trained model, they may all carry this specific signature, thus achieving the persistence and recognizability of the watermark.

In other words, by embedding the structured noise and the digital watermark, the following effect may be achieved: assuming that a party A generates audio A by using a model A, the audio A passes through an embedding model to generate audio E. A party B uses the audio E to train a model B to generate audio B. At this time, there may also be watermark information in the audio B. If a party C uses the audio B to train a model C to generate audio C, at this time, there may also be the watermark information in the audio C. In addition, after the party B trains the model B to a certain extent, if the party B uses audio D without any addition and inputs it to the model B trained by using the audio E, a generated trained audio may also have the watermark information of the audio E.

In this way, it can be ensured that the audio signal is consecutive and does not compromise the quality of the audio. By the method of selecting the embedding position and modulating the structured noise, effective copyright protection and tracing functions may be achieved without affecting the audio listening experience. In this way, an audio signal A′ carrying a watermark not only retains the content and quality of the original audio, but also has additional information identification and tracking capabilities.

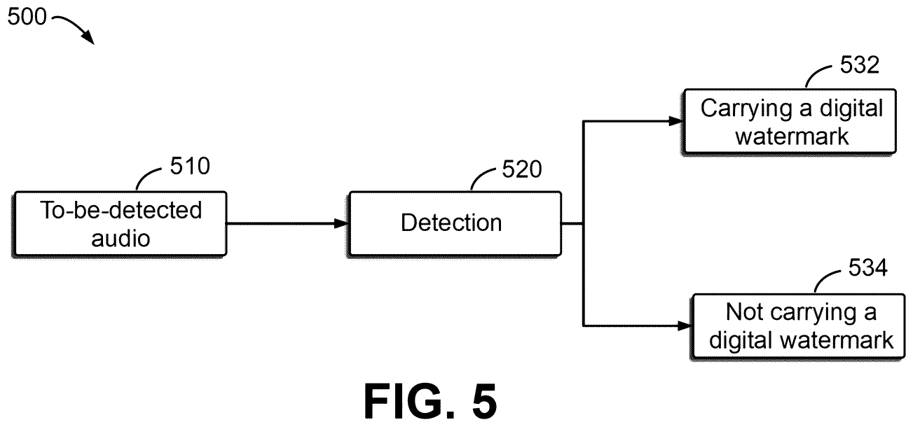

FIG. 5 is a schematic diagram of a process 500 for detecting whether audio carries a digital watermark according to some embodiments of the present disclosure. As shown in FIG. 5, a to-be-detected audio 510 is applied to an embedding model. The embedding model here is not only a pure embedding tool, but also integrates a detection function 520 for performing analysis on the to-be-detected audio 510.

Still referring to FIG. 5, the detection function 520 may output a classification result after receiving the to-be-detected audio 510. This classification result is generally based on the determining, by the detection function 520, whether the audio contains a digital watermark. Specifically, a working mechanism of the detection function 520 is shown in Equation (6):

$$δ ( {O}_{mw} , {O}_{b} ) = \{ \begin{matrix}1 , if correlation ( {O}_{mw} , {O}_{b} ) > {T}_{d} \\ 0 , otherwise\end{matrix} \qquad ( 6 )$$

wherein O_{mw} is a to-be-detected output that may carry a watermark, O_{b} is an output carrying the watermark, and T_{d} is a detection threshold. Referring to Equation (6), if the correlation between the to-be-detected output and the output carrying the watermark is greater than the detection threshold, it may be considered that the to-be-detected output contains the watermark, and thus a classification result 532 that there is the digital watermark may be obtained. If the similarity between the to-be-detected output and the output carrying the watermark does not reach the detection threshold, a classification result 534 that there is no digital watermark may be obtained and output. In some embodiments, the detection function 520 may be used in the model training process to determine whether there is a watermark generated, thereby adjusting parameters of the embedding model.

In this way, if a third party attempts to copy or use audio generated by a given party without the given party's authorization, the copyright of the audio can be proved by detecting information in a digital watermark enhanced by structured noise in the audio. With the help of a secondary detection function 520 of the system, a watermark in audio generated by a model trained with watermarked audio can be recognized, thereby tracing a data source of the model, and providing a powerful tool for data tracing and copyright verification.

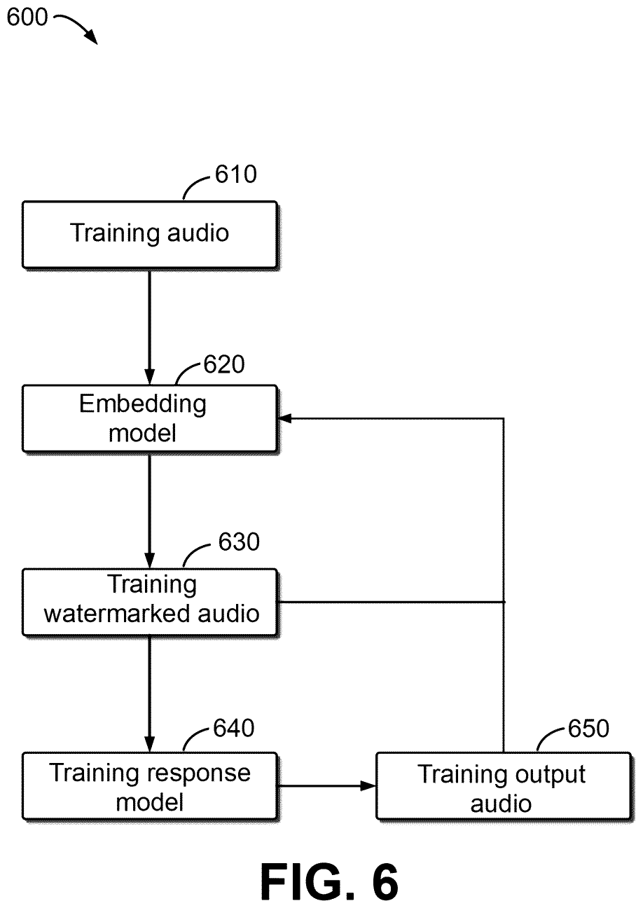

FIG. 6 is a schematic diagram of a process 600 for training an embedding model according to some embodiments of the present disclosure. As shown in FIG. 6, training audio 610 is first utilized as a starting point, and it is input to an embedding model 620. This step is a crucial start for model training, as by inputting a large amount of training audio data, the model can learn how to effectively embed a digital watermark and structured noise within the audio data.

After the training audio 610 is received, it is processed by the embedding model 620, and a training watermarked audio 630 may be obtained. The training watermarked audio 630 is input into a training response model 640. The training response model is a module specifically designed to evaluate the effectiveness of digital watermark embedding, which can analyze the presence or absence of a watermark in an input audio and generate a corresponding output. The training response model 640 may generate a training output audio 650, and the output audio contains response information of the model to the training watermarked audio 630. Specifically, as shown in Equation (7):

$${R}^{′} ( x ) = R ( x ) + \sum \qquad ( 7 )$$

wherein R(x) is the training watermarked audio 630, R′(x) is the training output audio 650, and Σ is the offset.

Next, the model is optimized by utilizing the loss (difference) between the training output audio 650 and the training watermarked audio 630. In other words, if the training response model 640 is trained by using the training watermarked audio 630 as a training dataset, the training output audio 650 needs to have watermark information Σ of the training watermarked audio 630. If there is no watermark information, it will be transmitted back to the embedding model 620. In this way, the parameters of the embedding model 620 can be adjusted to more accurately embed the watermark information and strengthen the signature mechanism of the watermarked audio to which the watermark is added by the embedding model.

Through such a complete training process, not only can an effective embedding model be obtained, but also the robustness of the embedded information can be ensured, thereby achieving the purpose of copyright protection and content authentication for the generated audio.

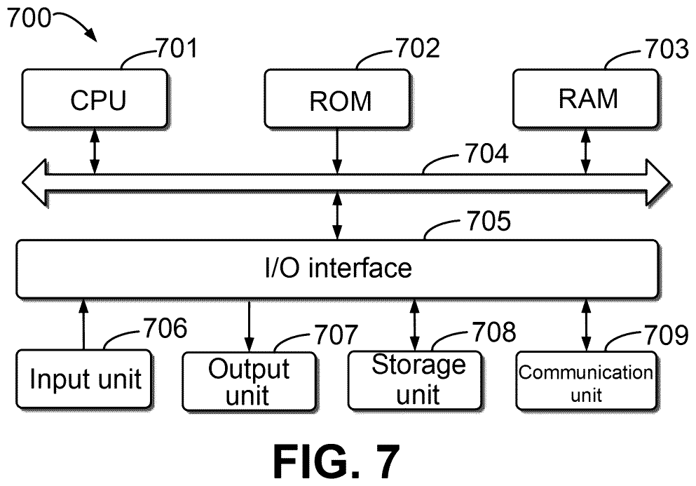

FIG. 7 is a block diagram of an example device 700 which can be used to implement embodiments of the present disclosure. As shown in the figure, the device 700 includes a computing unit 701, illustratively implemented as at least one central processing unit (CPU), that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An input/output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, the above-noted one or more CPUs, graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine-readable medium such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to perform the method 200 in any other suitable manner (such as by means of firmware).

The functions described herein may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should not be construed as an indication that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these are not to be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for determining a source of synthesized audio, comprising:
generating structured noise of first synthesized audio based on the first synthesized audio;
fusing a digital watermark into the structured noise;
determining a target embedding position of the digital watermark based on a spectrum of the first synthesized audio, wherein the digital watermark indicates a source of the first synthesized audio; and
generating second synthesized audio based on the fused structured noise, the first synthesized audio, and the target embedding position.

2. The method according to claim 1, wherein generating the structured noise of the first synthesized audio based on the first synthesized audio comprises:
generating a pseudo-random sequence based on the first synthesized audio; and
modulating the pseudo-random sequence to generate the structured noise.

3. The method according to claim 1, further comprising:
generating the digital watermark based on the first synthesized audio, wherein the digital watermark comprises at least an identification of a synthesizer of the first synthesized audio, timestamp information of the first synthesized audio, and information of a synthesizing model for synthesizing the first synthesized audio.

4. The method according to claim 3, wherein fusing the digital watermark into the structured noise comprises:
converting the digital watermark into a digital signal through an encoding function; and
fusing the digital signal of the digital watermark with the structured noise.

5. The method according to claim 3, wherein determining the target embedding position of the digital watermark based on the spectrum of the first synthesized audio comprises:
determining, in response to a short-time spectrum representation of the first synthesized audio at a first frequency and a first moment being lower than a human auditory threshold, and in response to the complexity of the spectrum of the first synthesized audio at the first frequency and the first moment being lower than a complexity threshold, that the spectrum at the first frequency and the first moment is the target embedding position.

6. The method according to claim 1, further comprising:
obtaining a target input audio for determining the source of the synthesized audio;
applying the target input audio to an embedding model to obtain a classification result of the embedding model for the target input audio;
determining, in response to the classification result being classified into a first class, that the target input audio carries the digital watermark; and
determining, in response to the classification result being classified into a second class, that the target input audio does not carry the digital watermark.

7. The method according to claim 6, further comprising:
training the embedding model based on a training second synthesized audio.

8. The method according to claim 7, wherein training the embedding model based on the training second synthesized audio comprises:
inputting a training first synthesized audio into the embedding model to generate the training second synthesized audio;
inputting the training second synthesized audio into a training response model, and generating a training output audio of the training response model; and
adjusting parameters of the embedding model based on the training output audio and the training second synthesized audio.

9. An electronic device, comprising:
at least one processor; and
a memory coupled to the at least one processor and having instructions stored therein, wherein the instructions, when executed by the at least one processor, cause the electronic device to perform actions comprising:
generating structured noise of first synthesized audio based on the first synthesized audio;
fusing a digital watermark into the structured noise;
determining a target embedding position of the digital watermark based on a spectrum of the first synthesized audio, wherein the digital watermark indicates a source of the first synthesized audio; and
generating second synthesized audio based on the fused structured noise, the first synthesized audio, and the target embedding position.

10. The electronic device according to claim 9, wherein generating the structured noise of the first synthesized audio based on the first synthesized audio comprises:
generating a pseudo-random sequence based on the first synthesized audio; and
modulating the pseudo-random sequence to generate the structured noise.

11. The electronic device according to claim 9, wherein the actions further comprise:
generating the digital watermark based on the first synthesized audio, wherein the digital watermark comprises at least an identification of a synthesizer of the first synthesized audio, timestamp information of the first synthesized audio, and information of a synthesizing model for synthesizing the first synthesized audio.

12. The electronic device according to claim 11, wherein fusing the digital watermark into the structured noise comprises:
converting the digital watermark into a digital signal through an encoding function; and
fusing the digital signal of the digital watermark with the structured noise.

13. The electronic device according to claim 11, wherein determining the target embedding position of the digital watermark based on the spectrum of the first synthesized audio comprises:
determining, in response to a short-time spectrum representation of the first synthesized audio at a first frequency and a first moment being lower than a human auditory threshold, and in response to the complexity of the spectrum of the first synthesized audio at the first frequency and the first moment being lower than a complexity threshold, that the spectrum at the first frequency and the first moment is the target embedding position.

14. The electronic device according to claim 9, wherein the actions further comprise:
obtaining a target input audio for determining the source of the synthesized audio;
applying the target input audio to an embedding model to obtain a classification result of the embedding model for the target input audio;
determining, in response to the classification result being classified into a first class, that the target input audio carries the digital watermark; and
determining, in response to the classification result being classified into a second class, that the target input audio does not carry the digital watermark.

15. The electronic device according to claim 14, wherein the actions further comprise:
training the embedding model based on a training second synthesized audio.

16. The electronic device according to claim 15, wherein training the embedding model based on the training second synthesized audio comprises:
inputting a training first synthesized audio into the embedding model to generate the training second synthesized audio;
inputting the training second synthesized audio into a training response model, and generating a training output audio of the training response model; and
adjusting parameters of the embedding model based on the training output audio and the training second synthesized audio.

17. A computer program product, the computer program product being tangibly stored on a non-transitory computer-readable medium and comprising machine-executable instructions, wherein the machine-executable instructions, when executed by a machine, cause the machine to perform actions comprising:
generating structured noise of first synthesized audio based on the first synthesized audio;
fusing a digital watermark into the structured noise;
determining a target embedding position of the digital watermark based on a spectrum of the first synthesized audio, wherein the digital watermark indicates a source of the first synthesized audio; and
generating second synthesized audio based on the fused structured noise, the first synthesized audio, and the target embedding position.

18. The computer program product according to claim 17, wherein generating the structured noise of the first synthesized audio based on the first synthesized audio comprises:
generating a pseudo-random sequence based on the first synthesized audio; and
modulating the pseudo-random sequence to generate the structured noise.

19. The computer program product according to claim 17, wherein the actions further comprise:
generating the digital watermark based on the first synthesized audio, wherein the digital watermark comprises at least an identification of a synthesizer of the first synthesized audio, timestamp information of the first synthesized audio, and information of a synthesizing model for synthesizing the first synthesized audio.

20. The computer program product according to claim 19, wherein fusing the digital watermark into the structured noise comprises:
converting the digital watermark into a digital signal through an encoding function; and
fusing the digital signal of the digital watermark with the structured noise.
